(19) United States
(12) Patent Application Publication
(10) Pub. No.: US 2021/0217096 A1
(43) Pub. Date: Jul. 15, 2021

(54) INFORMATION CENTER APPARATUS, TERMINAL, INFORMATION PROCESSING METHOD, AND PROGRAM

(71) Applicant: NEC Corporation, Tokyo (JP)

(72) Inventor: Tomohiro USAMI, Tokyo (JP)

(73) Assignee: NEC Corporation, Tokyo (JP)

(21) Appl. No.: 17/056,179

(22) PCT Filed: May 15, 2009
(86) PCT No.: PCT/JP2019/019246

§ 371 Date: Nov. 17, 2020

(30) Foreign Application Priority Data
May 18, 2018 (JP) 2018-095870

(51) Int. Cl. G06Q 40/08; G07C 5/08; G07C 5/00; H04W 4/029

(52) U.S. Cl. CPC G06Q 40/08; G07C 5/0816; H04W 4/029; G07C 5/008; G07C 5/085

(57) ABSTRACT

An information center apparatus includes: a communication part that transmits a request for providing information which records situation of an incident or accident to a terminal(s) and receives the information which records the situation of the incident or accident from the terminal; a measuring part that measures a communication traffic volume required to transmit the information by the terminal; and a recording part that records the measured communication traffic volume to provide an incentive to the terminal that accepts the request for providing information.

### REFERENCE TO RELATED APPLICATION

The present invention is based upon and claims the benefit of the priority of Japanese patent application No. 2018-095870, filed on May 18, 2018, the disclosure of which is incorporated herein in its entirety by reference thereto.

### FIELD

The present invention relates to an information center apparatus, a terminal, an information processing method, and a program.

### BACKGROUND

In recent years, with the spread of surveillance cameras, driving recorders (dashboard cameras), smartphones, etc., digital photographs and moving images have come to be taken everywhere. Some patent literatures propose to collect and utilize images and moving images taken by these devices.

Patent Literature (PTL) 1 discloses a collection system of video around an accident occurrence site, which can collect more videos at a time of occurrence of each traffic accident and improve analysis accuracy of a cause(s) of the accident. The PTL 1 discloses a configuration for acquiring videos around other vehicles stored in storage means of such other vehicles located around an occurrence site of an accident based on a notice from a vehicle that encountered the accident.

PTL 2 also discloses a peripheral information collection system which can acquire information not only from a vehicle concerned but also from vehicles in the vicinity of the vehicle concerned when the vehicle concerned is stolen or any emergency situation occurs during moving.

### CITATION LIST

### Patent Literature

PTL 1: Japanese Patent Kokai Publication No. JP2012-98105A

PTL2: Japanese Patent Kokai Publication No. JP2006-350520A

### SUMMARY

### Technical Problem

The following analysis has been given by the present invention. In the methods of PLT 1 and PLT 2, there is a problem that it is difficult to collect video information from each vehicle. In particular, this is because as in PLT 1, when a video is transmitted instead of a image, cost of transmitting data from a vehicle which saw the accident to the information center is currently borne by a user or the like on a side of the vehicle which saw the accident.

It is an object of the present invention to provide an information center apparatus, a terminal, an information processing method and a program which can collect images and moving images taken by various apparatus and contribute to promotion of their utilization.

### Solution to Problem

According to a first aspect, there is provided an information center apparatus, including: a communication part that transmits a request for providing information which records situation of an incident or accident to a terminal(s) and receives the information which records the situation of the incident or accident from the terminal. The information center apparatus further includes a measuring part that measures a communication traffic volume required to transmit the information by the terminal. The information center apparatus further includes a recording part that records the measured communication traffic volume to provide an incentive to the terminal that accepts the request for providing information.

According to a second aspect, there is provided a terminal which transmits information to the above described information center apparatus in response to the request for providing information which records situation of an incident or accident from the information center apparatus.

According to a third aspect, there is provided an information processing method, including: a step of transmitting a request for providing information which records situation of an incident or accident to a terminal(s) and receiving the information which records the situation of the incident or accident from the terminal; a step of measuring a communication traffic volume required to transmit the information by the terminal; and a step of recording the measured communication traffic volume to provide an incentive to the terminal that accepts the request for providing information. The present method is tied to a particular machine, namely, an information center apparatus that receives information from various terminals.

According to a fourth aspect, there is provided a program that causes a computer to execute processing, including: transmitting a request for providing information which records situation of an incident or accident to a terminal(s) and receiving the information which records the situation of the incident or accident from the terminal; measuring a communication traffic volume required to transmit the information by the terminal; and recording the measured communication traffic volume to provide an incentive to the terminal that accepts the request for providing information. It is to be noted that this program may be recorded on a computer-readable (non-transitory) storage medium. That is to say, the present invention may be embodied as a computer program product.

### Advantageous Effects of Invention

According to the present invention, it is possible to collect images and moving images taken by various apparatus and promote their utilization. Namely, the present invention converts the configuration described in Background into the information center apparatus whose information collecting performance is dramatically improved.

### BRIEF DESCRIPTION OF DRAWINGS

FIG. 1 illustrates a configuration according to an exemplary embodiment of the present invention.

FIG. 2 illustrates a relationship among entities accordig to a first exemplary embodiment of the present invention.

FIG. 3 illustrates a configuration accordig to the first exemplary embodiment of the present invention.

FIG. 4 illustrates a sequence diagram showing an operation (from reception of accident information to request for providing informaiton) according to the first exemplary embodiment of the present invention.

FIG. 5 illustrates an example of accident informaiton which is received by the information center apparatus according to the first exemplary embodiment of the present invention.

FIG. 6 illustrates a sequence diagram showing an operation (from request for providing informaiton to reception of information provided by a third party) according to the first exemplary embodiment of the present invention.

FIG. 7 illustrates an example of informaiton provided by a third party, which is received by the information center apparatus, according to the first exemplary embodiment of the present invention.

FIG. 8 illustrates another sequence diagram showing an operation (from request for providing informaiton to reception of information provided by a third party) according to the first exemplary embodiment of the present invention.

FIG. 9 illustrates a sequence diagram showing an operation (from reception of accident information to request for providing informaiton) according to a second exemplary embodiment of the present invention.

FIG. 10 illustrates a sequence diagram showing an operation (from request for providing informaiton to reception of information provided by a third party) according to a third exemplary embodiment of the present invention.

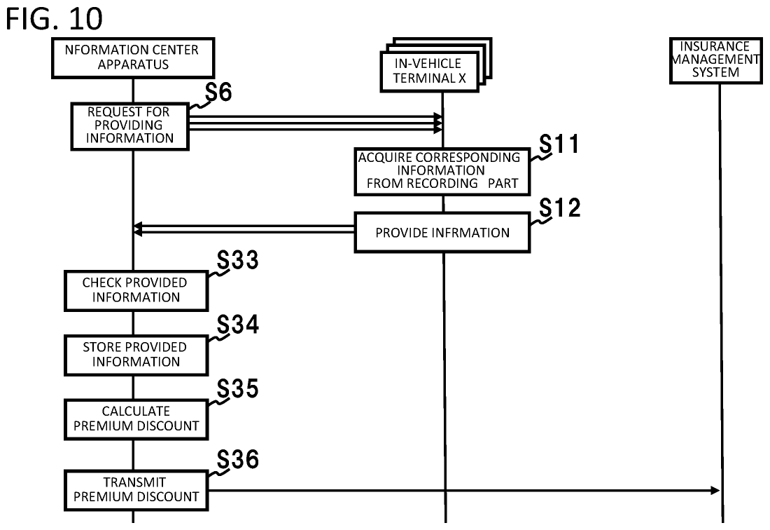

FIG. 11 illustrates a configuration of a computer that configures an information center apparatus according to the present invention.

### DESCRIPTION OF EXEMPLARY EMBODIMENTS

First, an outline of an exemplary embodiment of the present invention will be described with reference to drawings. In the following outline, reference signs of the drawings are denoted to each element as an example for the sake of convenience to facilitate understanding and is not intended to limit the present invention to the illustrated modes. An individual connection line between blocks in an individual drawing, etc. referred to hereinafter includes both one-way and two-way directions. A one-way arrow schematically illustrates a principal signal (data) flow and does not exclude bidirectionality. A program is executed via a computer apparatus, and the computer apparatus includes, for example, a processor, a storage device, an input device, a communication interface, and a display device as needed. In addition, the computer apparatus is configured to be capable of communicating with its internal device or an external apparatus (including a computer) via the communication interface through wired or wireless connection. While not illustrated, a port(s) or an interface(s) exists at an input-output connection point(s) in an individual block in the drawings. In the following description, “A and/or B” is used to mean A or B, or A and B.

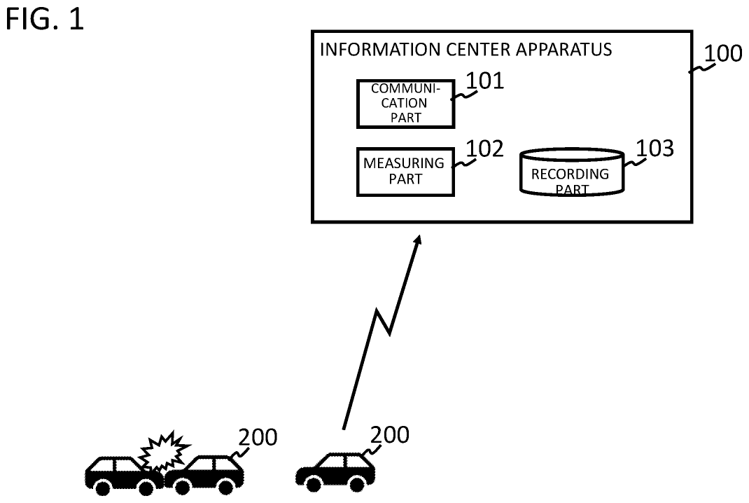

In an exemplary embodiment, the present invention can be realized by an information center apparatus 100 which includes a communication part 101, a measuring part 102 and a recording part 103 as illustrated in FIG. 1.

More concretely, a communication part 101 transmits a request for providing information which records situation of an incident or an accident to an in-vehicle terminal(s). The communication part 101 receives the information which records the situation of the incident or the accident from the terminal.

A measuring part 102 measures a communication traffic volume required to transmit the information by the terminal. Then, a recording part 103 records the measured communication traffic volume to provide an incentive to the terminal that accepts the request for providing information.

According to the information center apparatus 100, every time provision of the information which records situation of an incident or an accident from a terminal is received, it is possible to measure and record a communication traffic volume required for the provision. Based on the recorded communication traffic volume, it is possible to increase quantity and quality of the information to be provided by providing an incentive to action for providing the information. This information can be used for resolution of an incident and an accident, or the like, and an appropriate payout of insurance money.

### First Exemplary Embodiment

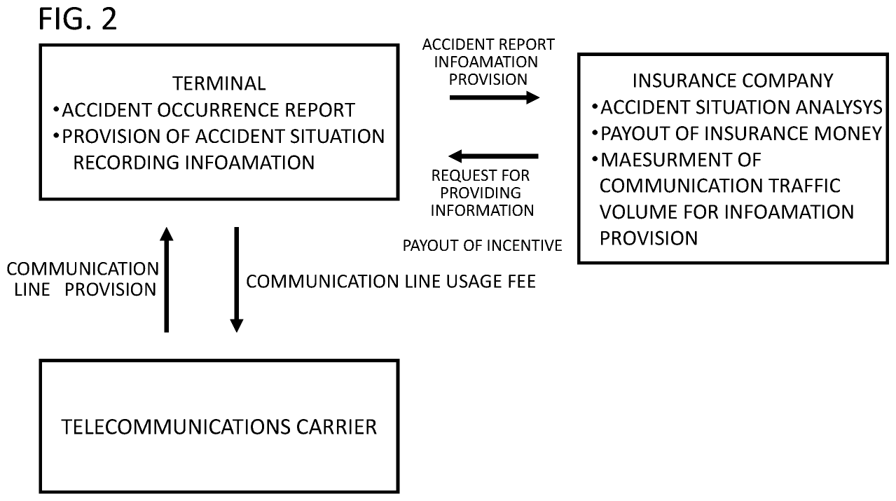

Next, a first exemplary embodiment of the present invention will be described in detail with reference to drawings. First, entities which will appear in every exemplary embodiment will be described. FIG. 2 illustrates a relationship among entities accordig to a first exemplary embodiment of the present invention. With reference to FIG. 2, a terminal(s), a telecommunications carrier(s), and an insurance company(ies) are shown.

A user of a terminal pays a communication line usage fee in returns for receiving provision of a communication line from a communication carrier. The type of a contract regarding the use of the communication line between a user of the terminal and the communication carrier may be any of a pay-as-you-go system, a flat rate system, or a combination of these. Even if it is a flat rate system, there may be an upper limit on the communication traffic volume per unit period of time, and by providing information, a part corresponding to the provided information in the communication traffic volume that was originally available will be consumed.

A user of a terminal has automobile insurance, and when the user of the terminal has encountered an accident or the like, an insurance company analyzes an accident situation and pays insurance money according to an insurance contract. In addition, the user of the terminal in the present exemplary embodiment also has an aspect as a witness of the accident. That is, the user of the terminal provides information effective for analyzing the accident situation, such as a recorded video of a driving recorder mounted on own vehicle, in response to a request(s) for providing information from the insurance company. The insurance company then performs payment of an incentive in return for provision of this information. The amount of this incentive (economic value) is calculated based on a communication traffic volume required to provide the information described later.

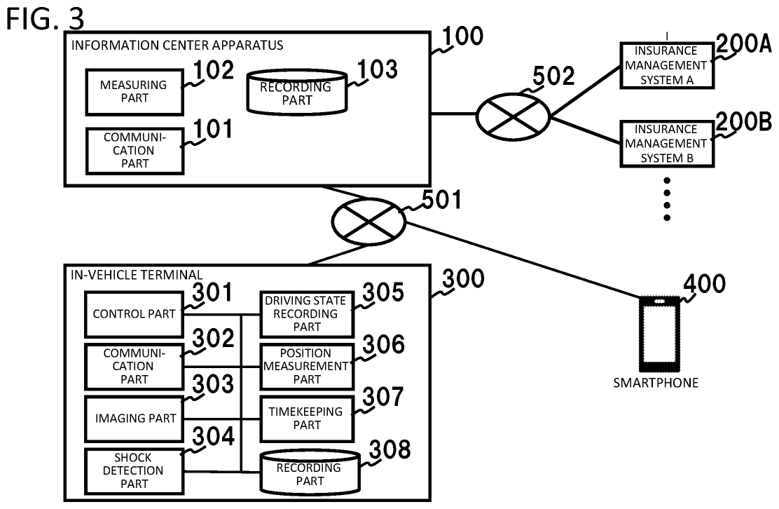

FIG. 3 illustrates a configuration accordig to the first exemplary embodiment of the present invention. With reference to FIG. 3, a configuration in which an information center apparatus 100, an in-vehicle terminal 300, and a smartphone 400 are connected via a network 501, which is a wireless network, is shown. Further, in an example of FIG. 3, the information center apparatus 100 is connected to the insurance management systems 200A and 200B of the insurance company via a network 502. In the example of FIG. 3, it is assumed that the networks 501 and 502 exist separately, but the network 501 and the network 502 may be the same network.

The information center apparatus 100 includes a communication part 101, a measurement part 102, and a recording part 103. When the communication part 101 receives accident information from the in-vehicle terminal 300 mounted on the vehicle which caused the accident or the driver's smartphone 400, the communication part 101 transmits a request for providing information to other in-vehicle terminals or the like. When the communication part 101 receives provision of information from the other in-vehicle terminal or the like, the communication part 101 requests the measurement part 102 to measure communication traffic volume.

The measuring part 102 measures a communication traffic volume required to transmit the information by the other in-vehicle terminal or the like.

The recording part 103 respectively records the information transmitted from the other in-vehicle terminal and the communication traffic volume measured by the measuring part 102. The communication traffic volume measured by the measuring part 102 is used as a basis for calculating a discount amount of insurance premium (referred as “premium” hereinafter) as an incentive or a reward for action for providing information of the terminal that is a transmission source of the information.

Further, in a more desirable mode, any one of the communication part 101, the measurement part 102, and the recording part 103 may determine whether or not the incentive is to be provided based on position information of the in-vehicle terminal 300 or the smartphone 400 included in the information received from the terminal.

The information center apparatus 100 as described above may be held and managed by a particular insurance company or may be configured to be held and managed by an insurance broker entrusted by the insurance company.

The in-vehicle terminal 300 includes a control part 301, a communication part 302, an imaging part 303, a shock detection part 304, a driving state recording part 305, a position measurement part 306, a timekeeping part 307, and a recording part 308.

The control part 301 controls each part of the in-vehicle terminal 300. The communication part 302 performs transmission of accident information to the information center apparatus 100, reception of a request for providing information from the information center apparatus 100, and provision of information to the information center apparatus 100, and so on.

The imaging part 303, the driving state recording part 305, the position measurement part 306, the timekeeping part 307, and the recording part 308 are each composed of recording devices, such as a camera, a driving state recording apparatus, a GPS (Global Positioning System), a timer, a memory card, and so on. Instead of arranging these discretely, a driving recorder configured to include these functions can also be used. The driving state recording apparatus is an apparatus that records the driving state of a steering wheel/access/brake and the like.

The shock detection part 304 detects a shock applied to the vehicle and determines whether or not the vehicle has had an accident or the like. When it is determined that the vehicle has had an accident or the like, the shock detection part 304 requests the control part 301 to transmit accident information.

As the in-vehicle terminal 300 as described above, a thing equivalent to the vehicle of PLT 1 having a function for notifying of occurrence of an accident can also be used.

As the smartphone 400, one having a general movie shooting function can be used.

The in-vehicle terminal 300 and the smartphone 400 hold information that can identify the insurance company of insurance which the user of these apparatuses has (hereinafter referred to as insurance ID) and information such as an insurance number that can identify a policyholder by the insurance company (hereinafter, referred to as a personal ID). The details of the operation when the in-vehicle terminal 300 and the smartphone 400 operate as the information providing side will be described later in the operation of the present exemplary embodiment.

The insurance management systems 200A and 200B of the insurance company perform discount processing of premium of the corresponding policyholder based on the premium discount request from the information center apparatus 100. Further, the insurance management systems 200A and 200B of the insurance company may have a function of responding to an inquiry of the insurance ID and the personal ID by a name of the policyholder or the like from the information center apparatus 100.

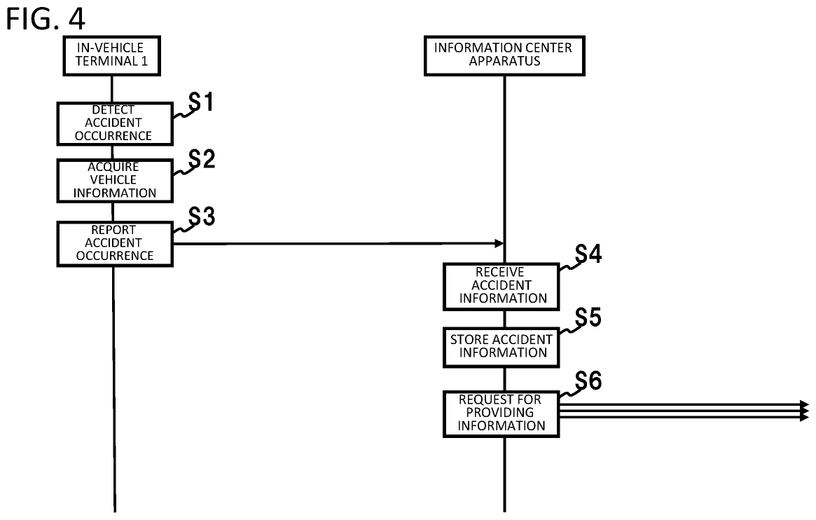

Subsequently, the operation of the present exemplary embodiment will be described in detail with reference to the drawings. FIG. 4 illustrates a sequence diagram showing an operation (reception of accident information) according to the first exemplary embodiment of the present invention. In the following description, it is assumed that an in-vehicle terminal 1 has encountered an accident and the in-vehicle terminal X is traveling around the accident site. Referring to FIG. 4, the in-vehicle terminal 1 mounted on the accident vehicle detects occurrence of an accident by the shock detection part 304 (step S1).

The in-vehicle terminal 1 acquires each information (hereinafter referred to as vehicle information) from the imaging part 303, the driving state recording part 305, the position measurement part 306, and the timekeeping part 307. If necessary, the in-vehicle terminal 1 may acquire past vehicle information from the recording part 308.

Next, the in-vehicle terminal 1 creates accident information for notifying of the occurrence of an accident by adding an insurance ID and a personal ID to the vehicle information acquired in step S2. Then, the in-vehicle terminal 1 transmits the accident information to the information center apparatus 100 to report the occurrence of the accident (step S3).

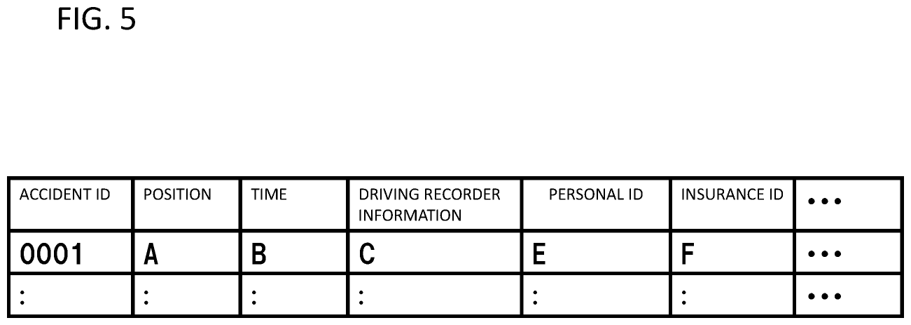

FIG. 5 illustrates an example of accident informaiton. In the example of FIG. 5, accident information in which the insurance ID and the personal ID are added to a position A, time B, and driving recorder information C (information obtained from the imaging part 303 and the driving state recording part 305) is shown. The accident ID is an ID added by the information center apparatus 100 side for uniquely identifying the accident.

The information center apparatus 100 receives an accident occurrence report including accident information from the in-vehicle terminal 1 (step S4). Here, the information center apparatus 100 may measure communication traffic volume required for transmission and reception of accident information by the measuring unit 102.

Next, the information center apparatus 100 stores the accident information received in step S4 and the measured communication traffic volume in the recording part 103 (step S5).

Next, the information center apparatus 100 transmits to other in-vehicle terminals and smartphones of pedestrians, a request for providing information including information on time and an accident occurrence site by using the position A and the time B included in the accident information (step S6). Further, a name of a nearby intersection, landmark information, or the like may be added to the accident occurrence site of the request for providing information for the smartphone as well as the position A of the accident information, that is, the latitude/longitude information by GPS.

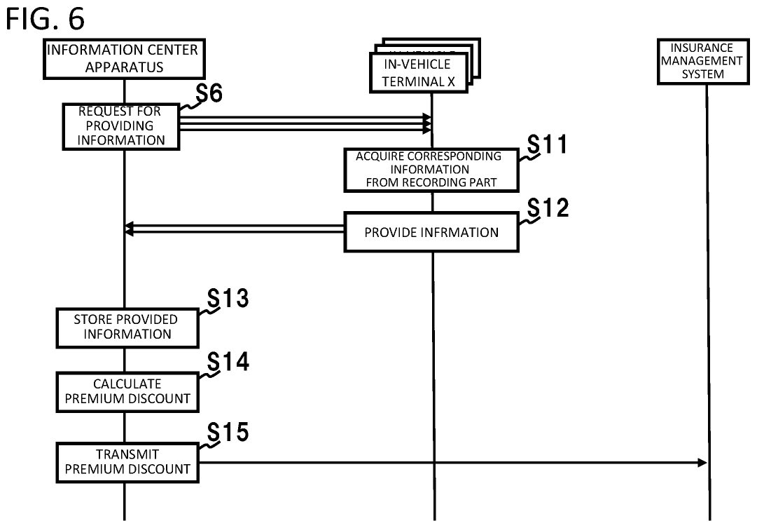

Subsequently, with reference to FIG. 6, an operation of an in-vehicle terminal X that received a request for providing informaiton and the information center apparatus that received the information provision will be described. Referring to FIG. 6, first, when the in-vehicle terminal X receives the request for providing informaiton from the information center apparatus 100, the in-vehicle terminal X acquires the driving recorder information which corresponds to information of the position measuring part 306 and the timekeeping part 307 from the recording part 308. (step S11).

Next, the in-vehicle terminal X transmits the information (information provided by a third party) acquired in the step S11 to the information center apparatus 100 (step S12; information provision).

The information center apparatus 100 measures the communication traffic volume of received information from the in-vehicle terminal X (information provided by a third party). Then, the information center apparatus 100 stores the received information (information provided by a third party) and its communication traffic volume in the recording part 103 in association with each other (step S13). As a method for measuring the communication traffic volume, in addition to the method for measuring the actual communication traffic volume, size of the driving recorder information Cx included in the information provided by a third party may be treated as an approximate communication traffic volume.

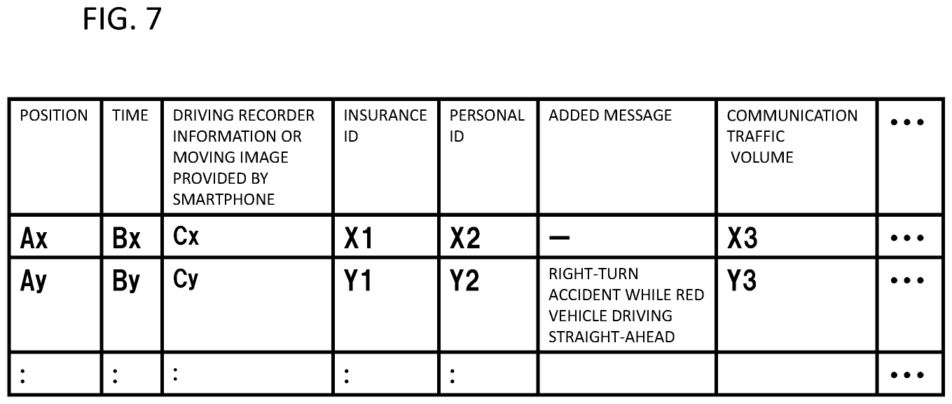

FIG. 7 illustrates an example of informaiton provided by a third party stored in the information center apparatus 100. With reference to FIG. 7, information provided by a third party is shown in which the insurance ID (X1) and the personal ID (X2) are added to a position Ax, time Bx, the driving recorder information Cx (information obtained from the imaging part 303 and the driving state recording part 305 of the in-vehicle terminal X). Here, the position Ax and the time Bx indicate the position and time of the in-vehicle terminal X that was traveling near the position A at the time B indicated in the request for providing information. Further, the insurance ID (X1) and the personal ID (X2) are the insurance ID and the personal ID of the insurance of the vehicle on which the in-vehicle terminal X is mounted. Further, in the example of FIG. 7, the communication traffic volume measured in step S13 is registered in association with the information provided by a third party.

Next, the information center apparatus 100 calculates the amount of the premium discount of the insurance which each information provider has as an incentive to each information provider using the communication traffic volume measured in step S13 (step S14). For example, the amount of the premium discount can be calculated by multiplying the communication traffic volume by the unit price.

Next, the information center apparatus 100 transmits the amount of the premium discount calculated in step S14 to the insurance management system of the insurance company corresponding to the insurance ID, by identifying an individual ID, and transmits a request of a discount on the amount of the premium (step S15).

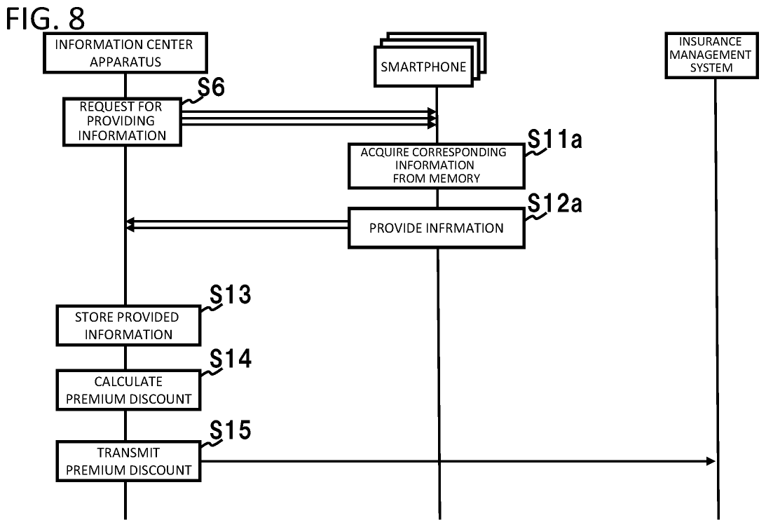

When information provision is performed from the smartphone 400, the sequence shown in FIG. 8 is applied to. The difference from the sequence of FIG. 6 is that information (information provided by a third party) acquired in step S11a is not the driving recorder information but a moving image or a still image taken by a camera of the smartphone 400, and these selections are performed by a user. Further, in the case of information provision from the smartphone 400, input of an additional message may be accepted when providing the information in step S12a. As a result, it becomes possible to provide useful information such as “an accident for the case of right-turn in which the red vehicle is driving straight-ahead” as shown in the entry on the second line of FIG. 7.

As described above, according to the present exemplary embodiment, it is possible to provide an incentive for the information providing act to the third party who provides the information. A reason why is that a configuration is employed in which the information center apparatus calculates an appropriate amount of return by measuring the communication traffic volume, and the amount is deducted from the premium of the insurance which the information provider has.

In addition, in the above described exemplary embodiment, it has been described that the insurance which the information provider has is discounted, but the example of the incentive is not limited to this. For example, money may be paid directly to witnesses using an external remittance system such as postal money order, mail transfer or bank transfer. Similarly, the information provider may be provided with virtual currency or points that can be used in the same way as money.

### Second Exemplary Embodiment

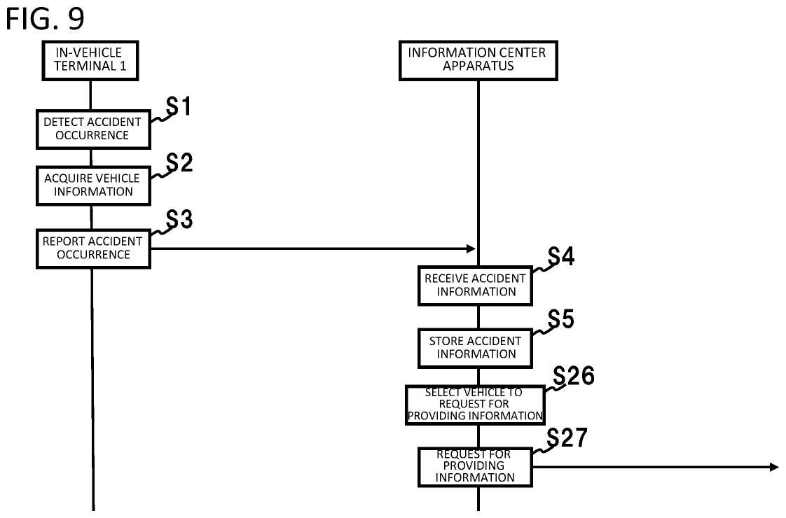

Next, a second exemplary embodiment in which the information center apparatus 100 narrows down the in-vehicle terminals and so on to which requests for providing information are made will be described. FIG. 9 illustrates a sequence diagram showing an operation (from reception of accident information to request for providing informaiton) according to a second exemplary embodiment of the present invention. The difference from the operation of the first embodiment shown in FIG. 4 resides in that the information center apparatus 100 periodically collects time and position information of an in-vehicle terminal(s), and after receiving accident information, at corresponding time, selects an in-vehicle terminal located near the accident site (step S26). Therefore, a request for providing information is transmitted to the in-vehicle terminal located near the accident site at the time when the accident occurs.

According to the present exemplary embodiment in which the destinations of the requests for providing information are narrowed down as described above, it is possible to collect necessary information while suppressing the total amount of premium discounts. Further, in the present exemplary embodiment, the in-vehicle terminal that has received the request for providing information may always provide the information.

### Third Exemplary Embodiment

Next, a third exemplary embodiment in which the information center apparatus 100 checks the provided information will be described. The difference from the first exemplary embodiment shown in FIG. 6 resides in that after receiving the information provided by a third party from the in-vehicle terminal X, a process is added in which the information center apparatus 100 checks the provided information. As this checking, it is conceivable to check whether or not the position Ax and the time Bx included in the information provided by the third party are close values respectively to the position and the time in the case where the accident occurred. Of course, in addition to the position Ax and the time Bx, it may be checked whether or not an appropriate moving image is recorded in the driving recorder information.

According to the third exemplary embodiment to check the information provided by a third party as described above, it is possible to collect necessary information while suppressing the total amount of premium discounts.

While the above exemplary embodiments of the present invention have been described, the present invention is not limited thereto. Further modifications, substitutions, or adjustments can be made without departing from the basic technical concept of the present invention. For example, the configurations of the networks and the elements and the representation modes of the messages illustrated in the individual drawings are merely used as examples to facilitate the understanding of the present invention. Thus, the present invention is not limited to the configurations illustrated in the drawings. In addition, “A and/or B” in the following description signifies at least one of A or B. While not illustrated, a port(s) or an interface(s) exists at an input-output connection point(s) in an individual block in the drawings.

Further, in the above-described embodiment, the information center apparatus 100 has been described as one, but it is also possible to adopt a configuration in which each insurance company has its own information center apparatus 100. In this case, the following mode can be considered as a method of transmitting a request for providing information to an in-vehicle terminal of a user who has insurance of another insurance company.

(Mode 1) Each insurance company shares information (position, etc.) of all in-vehicle terminals, and when an accident occurs, an insurance company of an insurance which an accident vehicle has transmits a request for providing information to all in-vehicle terminals regardless of the insurance company of the insurance which they have.
(Mode 2) Each insurance company holds information on an in-vehicle terminal mounted on the vehicle of its policyholder. When an accident occurs, an insurance company of an insurance which an accident vehicle has transmits a request for providing information to an in-vehicle terminal(s) of the policyholder who has an insurance of the insurance company itself (themselves) and an information center apparatus(es) of the other insurance company(ies). Then, the information center apparatus(es) of the other insurance company(ies) that have received the request for providing information transmits a request for providing information to an in-vehicle terminal(s) of the policyholders who has an insurance(s) of the company(ies) itself (themselves).

Further, in the above described exemplary embodiment, an example of providing a moving image or a still image recorded by a driving recorder to an insurance company has been mainly described, but the scope to which the present invention can be applied is not limited to this example. For example, it can be similarly applied to applications such as police or the like and other investigative authorities collecting images obtained by drones (unmanned flight vehicles) and surveillance cameras located in various places. In this case as well, incentives can be provided to installers of the surveillance cameras and owners of the drones, so that investigation materials can be collected quickly and extensively.

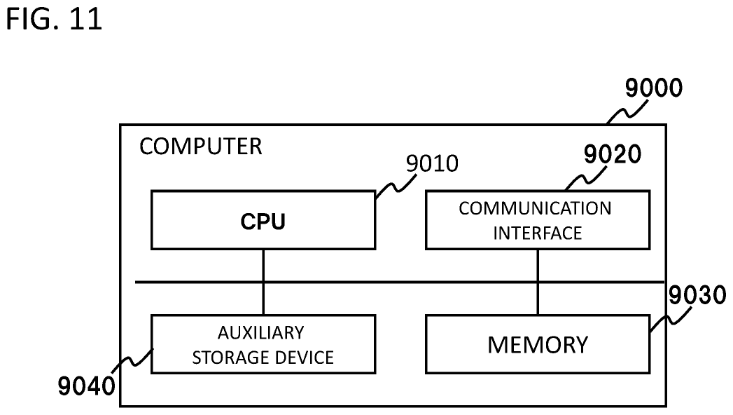

The procedures according to the first to third exemplary embodiments can be realized by a program that causes a computer (9000 in FIG. 11) functioning as an information center apparatus 100 to realize the function as the information center apparatus 100. Such computer is illustrated by a configuration, as an example, including a CPU (central processing unit) 9010, a communication interface 9020, a memory 9030, and an auxiliary storage device 9040 in FIG. 11. Namely, the CPU 9010 in FIG. 11 may be configured to execute a program for transmission of a request for providing information and a communication traffic volume measurement program and to perform processing for updating various calculation parameters stored in the auxiliary storage device 9040 or the like.

Namely, an individual part (processing means, function) of the information center apparatus 100 according to the above first to third exemplary embodiments may be realized by a computer program that causes a processor mounted in the information center apparatus to perform the corresponding processing described above by using its hardware.

Finally, suitable modes of the present invention will be summarized.

### [Mode 1]

(See the information center apparatus according to the above first aspect)

### [Mode 2]

It is preferable that the above described information center apparatus determines whether or not the incentive is to be provided based on position information of the terminal included in the information received from the terminal.

### [Mode 3]

The above described information center apparatus may employ a configuration to select a terminal(s) to which the request for providing information which records the situation of the incident or accident is transmitted based on the position information of the terminal(s).

### [Mode 4]

It is preferable that the terminal to which the above described information center apparatus transmits the request for providing information is an in-vehicle terminal on which a driving recorder is mounted.

### [Mode 5]

The communication part of the above described information apparatus may employ a configuration to transmit the request for providing information based on a notice from a user or an equipment that encounters an incident or accident.

### [Mode 6]

The above described information apparatus may employ a configuration to, as the incentive to provide the terminal, request an insurance company of an insurance which a user of the terminal has, to discount premium.

### [Mode 7]

(See the terminal according to the above second aspect)

### [Mode 8]

(See the information processing method according to the above third aspect)

### [Mode 9]

(See the program according to the above fourth aspect)

The above modes 7 to 9 can be expanded in the same way as mode 1 is expanded to modes 2 to 6.

The disclosure of each of the above Patent Literatures is incorporated herein by reference thereto. Variations and adjustments of the exemplary embodiments and examples are possible within the scope of the overall disclosure (including the claims) of the present invention and based on the basic technical concept of the present invention. Various combinations and selections (including partial deletion) of various disclosed elements (including the elements in each of the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not otherwise specified.

### REFERENCE SIGNS LIST

1, X, 300 in-vehicle terminal

100 information center apparatus

101 communication part

102 measuring part

103 recording part

200A, 200B insurance management system

301 control part

302 communication part

303 imaging part

304 shock detection part

305 driving state recording part

306 position measurement part

307 timekeeping part

308 recording part

400 smartphone

501, 502 network

9000 computer

9010 CPU

9020 communication interface

9030 memory

9040 auxiliary storage device

1. An information center apparatus, comprising:
at least a processor; and
a memory in circuit communication with the processor,
wherein the processor is configured to execute program instructions stored in the memory to implement:
a communication part that transmits a request for providing information which records situation of an incident or accident to a terminal(s) and receives the information which records the situation of the incident or accident from the terminal;
a measuring part that measures a communication traffic volume required to transmit the information by the terminal; and
a recording part that records the measured communication traffic volume to provide an incentive to the terminal that accepts the request for providing information.

2. The information center apparatus according to claim 1, wherein the processor is configured to execute the program instructions to implement:
that the information center apparatus determines whether or not the incentive is to be provided based on position information of the terminal included in the information received from the terminal.

3. The information center apparatus according to claim 1, wherein the processor is configured to execute the program instructions to implement:
that the information center apparatus selects a terminal(s) to which the request for providing information which records the situation of the incident or accident is transmitted based on the position information of the terminal(s).

4. The information center apparatus according to claim 1, wherein the terminal is an in-vehicle terminal on which a driving recorder is mounted.

5. The information center apparatus according to claim 1, wherein the processor is configured to execute the program instructions to implement:
that the communication part transmits the request for providing information based on a notice from a user or an equipment that encounters an incident or accident.

6. The information center apparatus according to claim 1, wherein the processor is configured to execute the program instructions to implement:
that, as the incentive, the information center apparatus requests an insurance company of an insurance which a user of the terminal has, to discount premium.

7. The information center apparatus according to claim 1, wherein the processor is configured to execute the program instructions to implement:
that, the information center apparatus:
periodically collects time and position information of a terminal(s);
selects a terminal(s) located near an accident site at a corresponding time based on a notice from a user or an equipment that encounters an incident or accident; and
transmits the request for providing information which records the situation of the incident or accident to the terminal(s).

8. A terminal, wherein
at least a processor; and
a memory in circuit communication with the processor,
wherein the processor is configured to execute program instructions stored in the memory to implement:
the terminal transmits information to the information center apparatus according to claim 1 in response to the request for providing information which records situation of an incident or accident from the information center apparatus.

9. An information processing method, comprising:
transmitting a request for providing information which records situation of an incident or accident to a terminal(s) and receiving the information which records the situation of the incident or accident from the terminal;
measuring a communication traffic volume required to transmit the information by the terminal; and
recording the measured communication traffic volume to provide an incentive to the terminal that accepts the request for providing information.

10. A computer-readable non-transient recording medium recording a program, the program that causes a computer to execute processing, comprising:
transmitting a request for providing information which records situation of an incident or accident to a terminal(s) and receiving the information which records the situation of the incident or accident from the terminal;
measuring a communication traffic volume required to transmit the information by the terminal; and
recording the measured communication traffic volume to provide an incentive to the terminal that accepts the request for providing information.

11. The method according to claim 9, wherein the method further comprising:
determining whether or not the incentive is to be provided based on position information of the terminal included in the information received from the terminal.

12. The method according to claim 9, wherein the method further comprising:
selecting a terminal(s) to which the request for providing information which records the situation of the incident or accident is transmitted based on the position information of the terminal(s).

13. The method according to claim 9, wherein the terminal is an in-vehicle terminal on which a driving recorder is mounted.

14. The method according to claim 9, wherein the method further comprising:
transmitting the request for providing information based on a notice from a user or an equipment that encounters an incident or accident.

15. The method according to claim 9, wherein the method further comprising:
as the incentive, requesting an insurance company of an insurance which a user of the terminal has, to discount premium.

16. The medium according to claim 10, wherein the program further causes a computer to execute processing, comprising:
determining whether or not the incentive is to be provided based on position information of the terminal included in the information received from the terminal.

17. The medium according to claim 10, wherein the program further causes a computer to execute processing, comprising:
selecting a terminal(s) to which the request for providing information which records the situation of the incident or accident is transmitted based on the position information of the terminal(s).

18. The medium according to claim 10, wherein the terminal is an in-vehicle terminal on which a driving recorder is mounted.

19. The medium according to claim 10, wherein the program further causes a computer to execute processing, comprising:
transmitting the request for providing information based on a notice from a user or an equipment that encounters an incident or accident.

20. The medium according to claim 10, wherein the program further causes a computer to execute processing, comprising:
as the incentive, requesting an insurance company of an insurance which a user of the terminal has, to discount premium.
